(19) United States
(12) Patent Application Publication
(10) Pub. No.: US 2005/0216932 A1
(43) Pub. Date: Sep. 29, 2005

(54) Targeted advertising in conjunction with on-demand media content

(76) Inventor: Daniel Danker, Sunnyvale, CA (US)

Correspondence Address: LEE & HAYES PLLC, 421 W RIVERSIDE AVENUE SUITE 500, SPOKANE, WA, 99201, US

(21) Appl. No.: 10/809,630

(22) Filed: Mar. 24, 2004

(51) Int. Cl. H04N 7/173; G06F 13/00; H04N 5/445; G06F 3/00

(52) U.S. Cl. 725/32; 725/34; 725/87

(57) ABSTRACT

Techniques for targeting advertisements to consumers of on-demand media content are described. When a television viewer chooses to record a broadcast program, an advertisement associated with the program is downloaded from a server. When the user chooses to watch the recorded program, the advertisement is rendered in conjunction with the recorded program.

### TECHNICAL FIELD

This invention relates to targeted advertising, and more specifically to targeted advertising in conjunction with on-demand media content.

### BACKGROUND

Technological advances have led to consumer use of digital video recorders (DVRs), which enable television viewers to digitally record broadcast television programs, which are then stored on a hard drive. A significant disadvantage of DVRs, from the perspective of a cable television company, is that they enable a viewer to skip advertisements, which are an important revenue generator for the cable companies. Advertisers are less willing to pay for advertising spots when they are aware that the television viewers can easily avoid watching the advertisements by using a DVR to record and then later watch a particular program, skipping the commercials.

Accordingly, a need exists for a technique that enables advertisements to be targeted to viewers using digital video recorders.

### SUMMARY

Techniques for targeting advertisements in conjunction with on-demand media content are described. When a television viewer chooses to record a particular broadcast program, an advertisement associated with the selected program is downloaded and stored. When the television viewer chooses to watch the program that has been recorded, the advertisement is also played. In an exemplary implementation, the advertisement is played with a fast-forward mode disabled, preventing the television viewer from skipping the advertisement. Ad tracking data may be gathered that indicates, for example, how often a particular advertisement is played and whether or not a viewer attempts to fast-forward through the advertisement.

### BRIEF DESCRIPTION OF THE DRAWINGS

FIG. 1 is a pictorial diagram that illustrates a targeted advertising user experience.

FIG. 2 is a block diagram that illustrates an exemplary environment in which targeted advertising in conjunction with on-demand video may be implemented.

FIG. 3 is a block diagram that illustrates select components of an exemplary client device as illustrated in FIG. 2.

FIG. 4 is a block diagram that illustrates select components of an exemplary ad application server as illustrated in FIG. 2.

FIG. 5 is a flow diagram that illustrates an exemplary method for presenting targeted advertisements to a viewer of on-demand media content.

FIG. 6 is a flow diagram that illustrates an exemplary method for targeting advertisements to a viewer of on-demand media content.

### DETAILED DESCRIPTION

Overview

The embodiments described below provide techniques for targeting advertisements in conjunction with on-demand media content. In the described exemplary implementation, electronic program guide data is broadcast to a client device that is implemented, for example, as a digital video recorder (DVR). A user may schedule the client device to record a particular television program that is scheduled for broadcast. When the television program is broadcast, the client device records the program, which can then be viewed by the user at a later time.

When the client device is scheduled to record a particular program, data identifying the program is transmitted to a server. The server identifies one or more advertisements to be shown to a viewer when the program is viewed (after it is recorded). These advertisements are transmitted to and stored on the client device. When a user chooses to watch the previously recorded program, one or more of the identified advertisements are shown first, followed by the previously recorded program.

In an exemplary implementation, the advertisements are shown with a fast forward mode disabled, thereby forcing the viewer to watch the advertisement before watching the previously recorded program. In this way, advertisers can be assured that an advertisement is shown to viewers of a particular program, even if the program is recorded and watched later using DVR technology that typically enables viewers to skip commercials that are originally broadcast with the television program.

Similarly, viewers may order video-on-demand from a server system. The requested video is transmitted to the client device to be viewed by the user. In an exemplary implementation, video-on-demand that is presented to a viewer in this way may be configured to allow trick modes (e.g., fast forward, rewind, pause, etc.). However, an advertisement may be transmitted along with the requested video-on-demand such that the advertisement must be played (with trick-modes disabled) before the requested video-on-demand is played. This ensures that viewers of the on-demand video are also shown the particular advertisement.

Furthermore, client devices may generate data that indicates which advertisements are shown to viewers of on-demand video (either requested video-on-demand or previously recorded programs). The data that is generated may also provide other information, including, but not limited to, how often an advertisement is shown, dates and times the advertisement is shown, and whether or not a viewer attempts to fast-forward through the advertisement. This data may be generated on the client device and later transmitted to a server where the data may then be used, for example, to bill advertisers or to provide feedback to advertisers.

User Experience

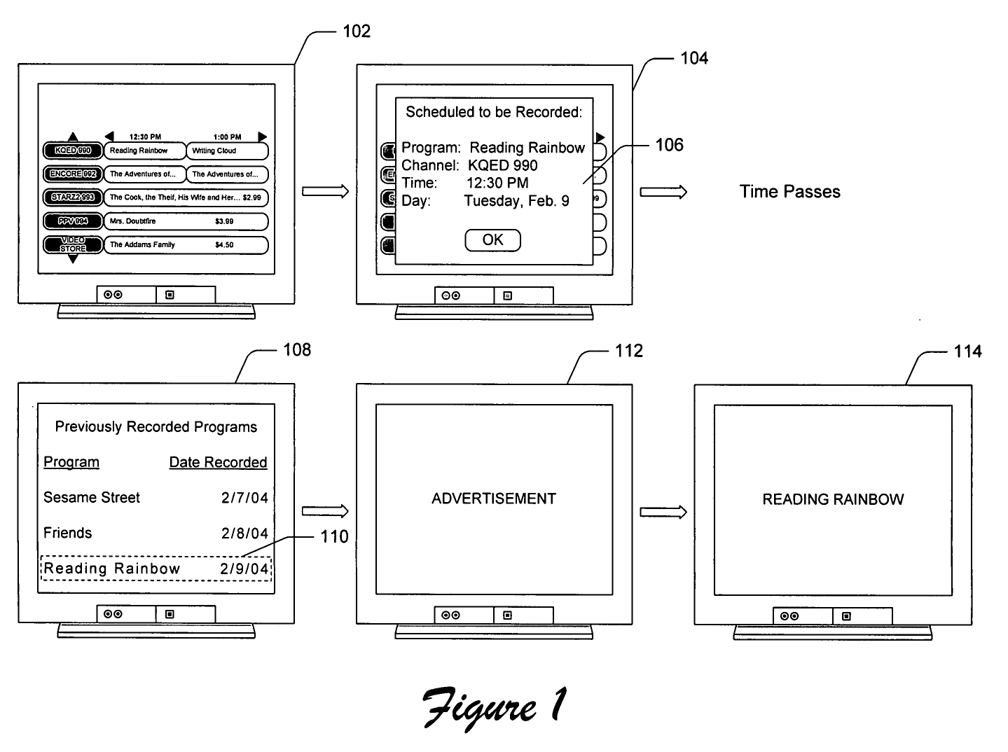

FIG. 1 illustrates an exemplary targeted advertising user experience according to the exemplary implementation described herein. Television display 102 illustrates display of an interactive electronic program guide from which a user may select a program to watch or record. Television display 104 illustrates an exemplary confirmation 106 that may be displayed when a user schedules a particular program to be recorded. In the illustrated example, the airing of “Reading Rainbow” that is scheduled for broadcast on February 9 at 12:30 pm on channel 990 has been scheduled to be recorded.

Time then passes, during which the scheduled program is recorded and an advertisement associated with the program (“Reading Rainbow”) is downloaded.

Television display 108 illustrates an exemplary display of a list of programs that have been previously recorded and are available for viewing. In the illustrated example, “Reading Rainbow” 110 is selected by the viewer.

Television display 112 illustrates display of an advertisement in response to a viewer selecting to watch a previously recorded episode of “Reading Rainbow”.

Television display 114 illustrates display of the selected program, after conclusion of the advertisement.

FIG. 1 illustrates one way in which a targeted advertisement may be rendered for a viewer of a television program that has been previously recorded using, for example, a digital video recorder (DVR). However, advertisements may be targeted for other types of on-demand media content and/or using other types of client devices.

Network Environment

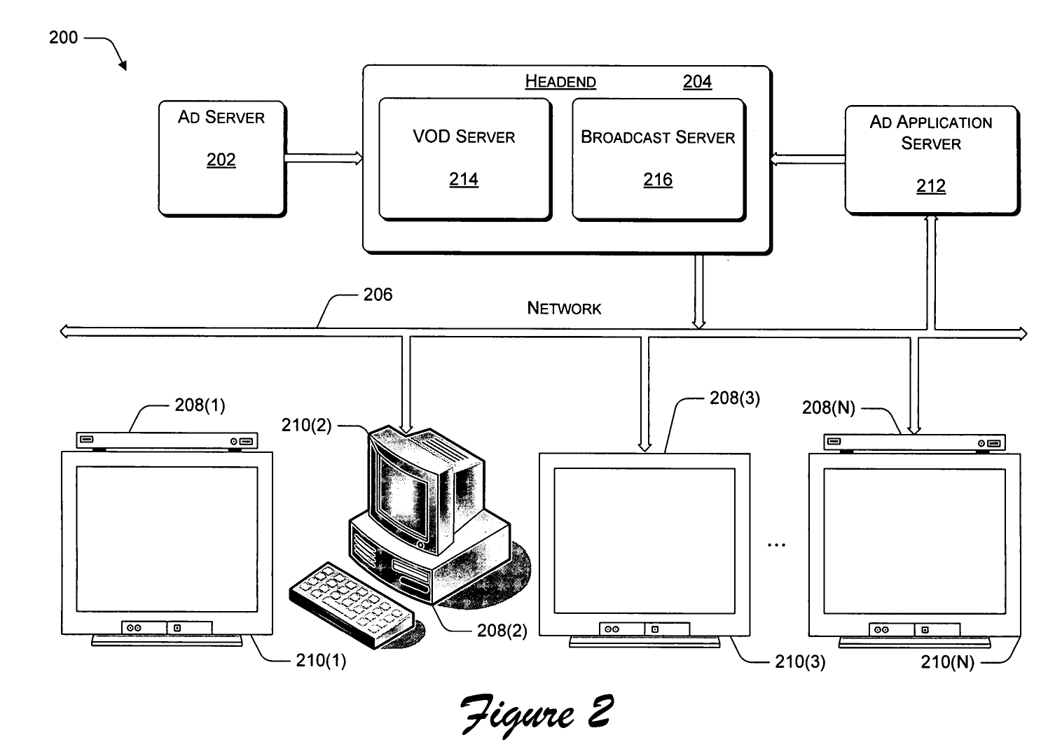

FIG. 2 illustrates an exemplary environment 200 in which targeted advertising in conjunction with on-demand media content may be implemented. Environment 200 includes an ad server 202, a headend 204, a network 206, multiple client devices 208(1), 208(2), 208(3), . . . , 208(N), each with an associated display device 210(1), 210(2), 210(3), . . . , 210(N), and an ad application server 212. In the illustrated implementation, headend 204 is representative of a cable television system headend, and client devices 208 are representative of television set-top boxes or any other type of client device configured to receive electronic program guide data and broadcast media content (e.g., television programs) over network 206. Client devices 208 may also be configured to record broadcast media content that is received. Client devices 208 may be implemented as any of a number of devices, including a cable television set-top box, a digital video recorder (DVR), a personal computer, and so on.

Exemplary ad server 202 aggregates advertisement content and metadata from multiple advertisers. Advertisement metadata may include business rules that define, for example, how often a particular advertisement is to be broadcast, when the advertisement expires, days and/or times at which the advertisement is to be broadcast, television programs during which the advertisement is to be broadcast, and so on. In an exemplary implementation, ad server 202 supplies advertisements and the associated metadata to one or more content providers (not shown), such as broadcast television networks, where the ads may be inserted into broadcast television programs. Ad server 202 may also supply advertisements and associated metadata to headend 204, where the ads may be targeted to viewers of on-demand video.

Exemplary headend 204 includes VOD server 214 and broadcast server 216. Headend 204 typically includes other components as well, which are not illustrated in FIG. 2, such as a processor, one or more memory components, one or more network interfaces, and so on.

VOD server 214 is configured to store and transmit video content that is available to television viewers on demand. In the described implementation, VOD server 214 is further configured to store and transmit advertisements and associated metadata that are to be targeted to viewers of on-demand video, including broadcast programs that are recorded by the viewers using a digital recording device.

Broadcast server 216 is configured to transmit electronic program guide data over network 206 to one or more of the client devices 208. EPG data is broadcast over an out-of-band portion or an in-band portion of network 206. In the illustrated example, broadcast server 216 is also configured to receive broadcast television programs, typically from a satellite link (not shown in FIG. 2) and re-modulate the received broadcast signals onto broadcast network 206.

Client devices 208(1), 208(2), 208(3), . . . , 208(N) are configured to receive broadcast television programs, electronic program guide data, targeted advertisements, and other data (e.g., video-on-demand content, advertisement metadata, etc.) over broadcast network 206. Client devices 208 may be implemented as any of a number of devices. For example, a client device 208(1) is implemented as a television set-top box that includes DVR capabilities. Client device 208(1) is coupled to a television 210(1) for presenting the content received by the client device (e.g., audio data and video data), as well as a graphical user interface.

Client device 208(2) is implemented as a personal computer that includes a hard drive. Personal computer 208(2) is coupled to a computer monitor or television 210(2) for presenting media content that is received over network 206.

Client device 208(3) is an example of a combination television 210(3) and integrated set-top box 218. In this example, the various components and functionality of the set-top box are incorporated into the television, rather than using two separate devices. The set-top box incorporated into the television receives broadcast signals via broadcast network 206.

A particular client device 208 can be coupled to any number of televisions 210 and/or similar devices that can be implemented to display or otherwise render content. Similarly, any number of client devices 208 can be coupled to a television 210. For example, a personal computer may be implemented as an additional client device capable of receiving EPG data and/or media content and communicating with a set-top box or television.

In alternate implementations, client devices 208 may receive broadcast signals via the Internet or any other broadcast medium, including, but not limited to, a cable television network, telephone twisted pair cables, and so on.

In an exemplary implementation, ad application server 212 is configured to support targeted advertising by mapping advertisements to media content such as television programs and on-demand videos. Ad application server 212 receives schedules of programs to be recorded from client devices 208. The recording schedule data is then compared to the advertisement/program mappings to identify advertisements that are to be shown when a viewer chooses to watch a particular program that has been previously recorded. Ad application server 212 then transmits data to headend 204 identifying which ads are to be transmitted to which client devices.

In an alternate implementation, ad application server 212 may be configured to identify advertisements that are to be shown when a viewer chooses to watch a particular program that has been previously recorded based on a day and/or time. For example, a family-friendly advertisement may be displayed with a particular pre-recorded program if a viewer chooses to watch the program between the hours of 4 pm and 8 pm while a more adult-oriented advertisement may be displayed with the particular pre-recorded program if the viewer chooses to watch the program between the hours of 8 pm and 1 am.

Similar associations may be made based on day. For example, a child-friendly advertisement may be shown when a pre-recorded program is selected to be viewed on a Saturday morning, but an adult-oriented advertisement may be shown when the pre-recorded program is selected to be viewed on a Wednesday.

Combinations of day and time may also be factors for determining which advertisement to display in conjunction with a particular pre-recorded program. For example one advertisement may be shown in conjunction with a pre-recorded program on a Thursday night, but a different advertisement may be shown in conjunction with the same pre-recorded program on a Saturday morning.

In an exemplary implementation, ad application server 212 also receives tracking data that identifies which advertisements have been rendered using client devices 208. The ad tracking data may also indicate, for example, a number of times a particular ad has been shown, dates and times that the ad has been shown, and whether or not viewers have attempted to fast-forward through (or otherwise skip) the ad.

In an alternate implementation ad application server 212 may support multiple headend systems. Alternatively, ad application server 212 may be implemented as a component of a headend 204.

Exemplary Client Device

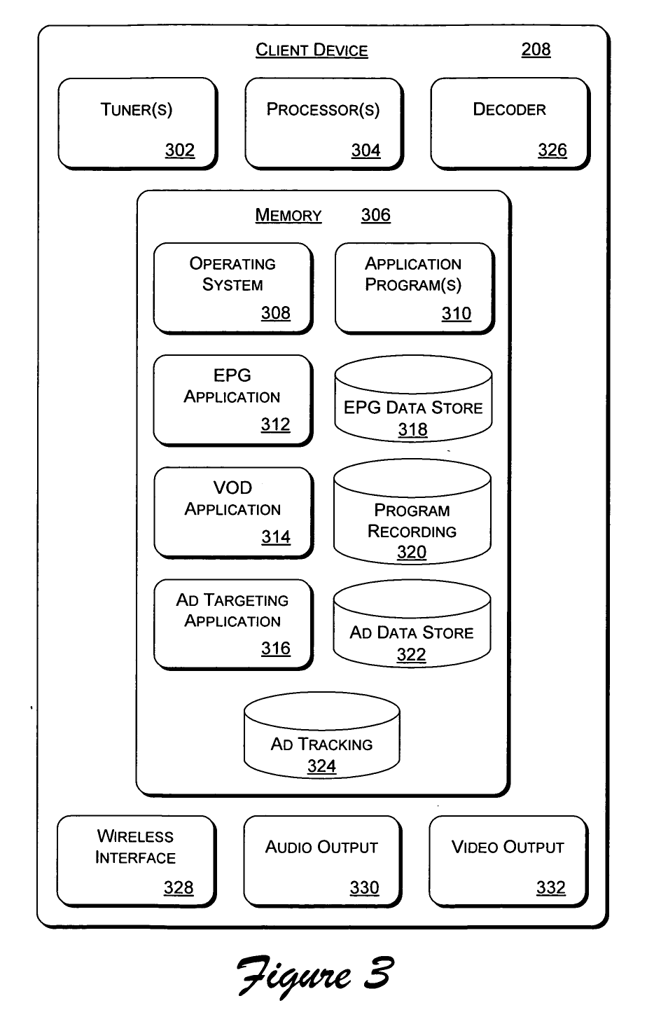

FIG. 3 illustrates select components of an exemplary client device 208. As described above, client device 208 can be implemented in any number of embodiments, for example, as a set-top box, a TV recorder with a hard disk, a personal computer, and so forth. Exemplary client device 208 includes one or more tuners 302. Tuners 302 are representative of one or more in-band tuners that may be configured to tune to various frequencies or channels to receive television signals, as well as one or more out-of-band tuners that may be configured to tune to one or more broadcast channels over which other data, such as electronic program guide (EPG) data and targeted advertisements, may be broadcast to client device 208.

Client device 208 also includes one or more processors 304 and one or more memory components 306. Examples of possible memory components include a random access memory (RAM), a disk drive, and a non-volatile memory (e.g., ROM, Flash, EPROM, EEPROM, etc.). Alternative implementations of client device 208 can include a range of processing and memory capabilities, and may include more or fewer types of memory components than those listed.

Processor(s) 304 process various instructions to control the operation of client device 208 and to communicate with other electronic and computing devices. The memory 306 stores various information and/or data such as media content, targeted advertisements, EPG data, configuration information for client device 208, graphical user interface information, viewing history data, and so on.

An operating system 308 and one or more application programs 310 may be stored in memory 306 and executed on processor 304 to provide a runtime environment. A runtime environment facilitates extensibility of client device 208 by allowing various interfaces to be defined that, in turn, allow application programs 310 to interact with client device 208. The application programs 310 that may be implemented at client device 208 can include, for example, a video-on-demand application for enabling a user to purchase VOD content. Electronic program guide (EPG) application 312, VOD application 314, and ad targeting application 316 are three specific applications that may be stored in memory 306 and executed on processor(s) 304.

EPG application 312 receives EPG data that is broadcast from headend 204. The EPG data that is received may then be stored in EPG data store 318. Typically, the EPG data that is received identifies media content that will be available during a particular period of time (e.g., the next two weeks). EPG application 312 provides a user interface that enables a user to select a broadcast program to watch or to schedule a broadcast program to be recorded.

Program recording data repository 320 is configured to maintain media content (e.g., television programs) that have been recorded. Program recording data repository 320 may also be configured to maintain program recording schedule data that identifies programs that have been scheduled to be recorded.

VOD application 314 is configured to provide a user interface that displays a listing of on-demand video that is available to a viewer. The on-demand video may include programs that have been previously recorded (stored in program recording data repository 320) and/or on-demand video that is available to be downloaded from VOD server 214.

EPG data store 318 may be implemented in any number of ways to store EPG data. For example, EPG data store 318 may be implemented as a relational database, an object-oriented database, a set of one or more text files, a set of one or more XML files, and so on.

Ad data store 322 maintains targeted advertisements that have been received from headend 204 to be rendered in association with programs that have been (or are scheduled to be) recorded.

Ad targeting application 316 causes an associated advertisement to be played when a viewer chooses to watch a previously recorded program. As described above, any number of methods may be used to associate a particular advertisement with a particular playing of a previously recorded program. In an exemplary implementation, ad targeting application 316 also gathers tracking data associated with the targeted ads that are played. The tracking data is stored in ad tracking data repository 324. Ad targeting application 316 transmits the ad tracking data from ad tracking data repository 324 to ad application server 212.

In an alternate implementation, ad data store 322 may be combined with program recording data repository 320. In such an implementation, the targeted advertisements are stored with a flag to prevent the ads from being displayed in a listing of available previously recorded programs.

Client device 208 also includes a decoder 326 to decode a broadcast signal, such as DVB, MPEG-2, WM9, or other digitally encoded signal. Client device 208 further includes a wireless interface 328 that allows client device 208 to receive input commands and other information from a user-operated input device, such as from a remote control device or from another IR, Bluetooth, or similar RF input device.

Client device 208 also includes an audio output 330 and a video output 332 that provide signals to a television or other display device 210 that processes and/or presents or otherwise renders the audio and video data.

Client device 208 may also include other components, which are not illustrated in this example for simplicity purposes. For instance, client device 208 may include a user interface application and user interface lights, buttons, controls, etc. to facilitate viewer interaction with the device.

Exemplary Ad Application Server

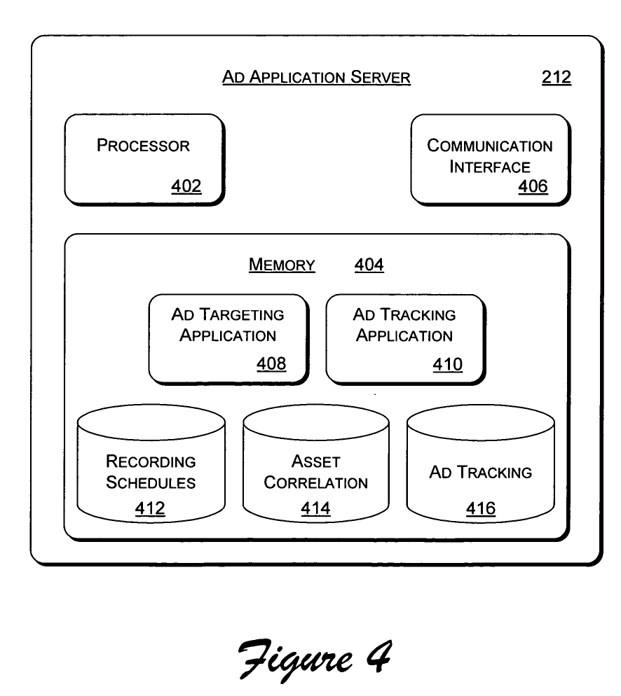

FIG. 4 illustrates select components of an exemplary ad application server 212. Ad application server 212 includes processor 402, memory 404 and communication interface 406. Ad targeting application 408 and ad tracking application 410 are stored in memory 404 and executed on processor 402. Recording schedules data repository 412, asset correlation data repository 414 and ad tracking data repository 416 are also stored in memory 404 to support ad targeting application 408 and ad tracking application 410.

Communication interface 406 enables transfer of data between ad application server 212, client device 208, and headend 204. Ad targeting application 408 receives from client device 208 data that identifies broadcast television programs that are scheduled to be recorded on a client device 208. The scheduled recording data is stored in recording schedules data repository 412. Data identifying associations between advertisements and broadcast television programs is stored in asset correlation data repository 414. In an exemplary implementation, asset correlation data repository 414 is populated with data that is received from headend 204 or from ad server 202.

Ad targeting application 408 compares television programs identified in recording schedules data repository 412 to television programs identified in asset correlation data repository 414. Ad targeting application 408 uses this comparison to identify ads to be targeted to the viewers of the programs that are scheduled to be recorded. Ad targeting application 408 transmits data to headend 204 that identifies the targeted advertisements associated with the programs that are scheduled to be recorded. In a scenario in which different ads are to be targeted depending on a day and/or time at which the previously recorded program is selected for playback, multiple ads and associated metadata identifying conditions under which each ad is to be played are transmitted to headend 204.

Ad tracking application 410 receives ad tracking data from client devices 208 after targeted advertisements have been played. In an exemplary implementation, the ad tracking data identifies which advertisements have been rendered and which programs they have been rendered in association with. The ad tracking data may also include additional information, which may include, but is not limited to, statistics identifying how often a particular ad has been rendered, days and/or times the ad has been rendered, and whether or not a viewer has attempted to fast-forward through the ad. The ad tracking data that is received is stored in ad tracking data repository 416. The ad tracking data is then available to be transmitted to headend 204, for example, to be used to generate billing data associated with particular advertisers.

Targeted Advertising Methods

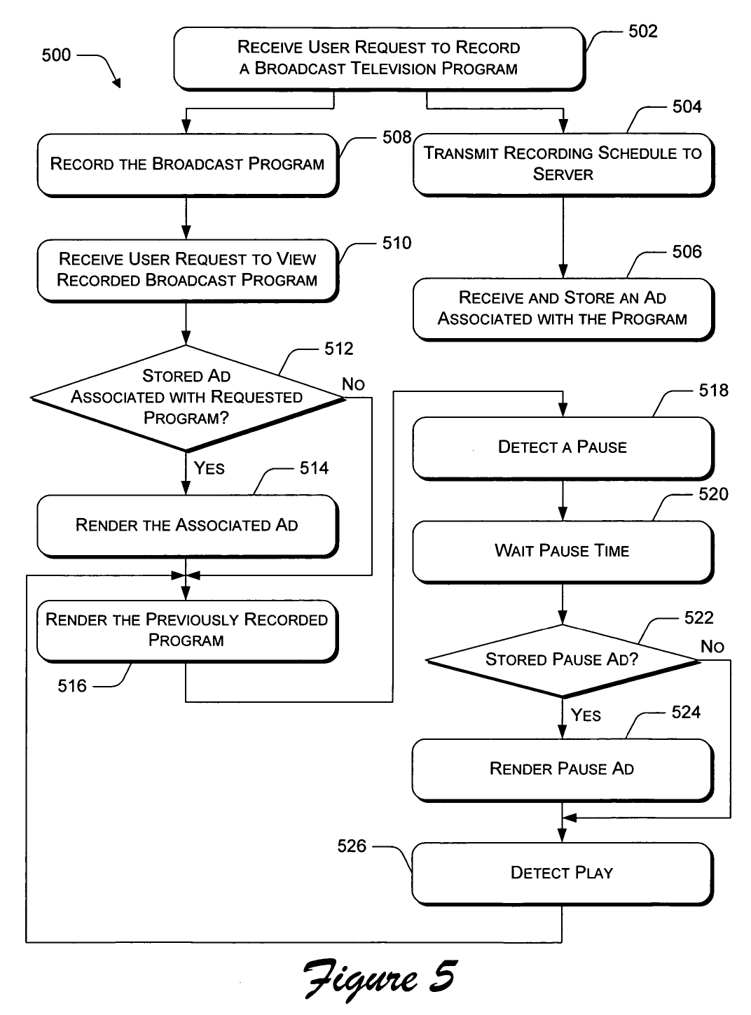

FIG. 5 is a flow diagram that illustrates an exemplary method 500 for targeting advertisements to viewers of on-demand media content. The illustrated process can be implemented in any suitable hardware, software, firmware or combination thereof.

At block 502, a client device receives a user request to record a particular television program scheduled for broadcast. For example, a user selects a program through EPG application 312 and indicates that the program is to be recorded.

At block 504, the client device transmits data indicating the television program that is scheduled to be recorded. For example, recording schedule data is stored in program recording data repository 320 and ad targeting application 316 transmits the recording schedule data to ad application server 212.

At block 506, client device 208 receives and stores one or more advertisements associated with the recorded program. For example, multiple targeted advertisement and associated metadata that describes conditions under which each advertisement is to be shown is received over network 206 from VOD server 214 and is stored in ad data store 322.

At block 508, client device 208 records the scheduled broadcast television program.

At block 510, client device 208 receives a user request to view the recorded program. For example, using a user interface provided by VOD application 314, a user selects a previously recorded program from a list of available on-demand video.

At block 512, client device 208 determines whether or not an advertisement associated with the requested program is stored in ad data store 322. For example, it is possible that there either is no advertisement to be targeted to viewers of the requested program, or the client device may not have received the targeted advertisement before the viewer requests to watch the recorded program.

At block 514, when it is determined that there is a targeted advertisement associated with the requested program (the “Yes” branch from block 512), client device 208 renders the advertisement that is associated with the recorded program. For example, ad targeting application 316 causes the associated advertisement (which is stored in ad data store 322) to be rendered. Metadata associated with the advertisement indicates how the advertisement is rendered. For example, metadata may indicate that fast-forward is to be disabled during the playing of the advertisement.

In an implementation that supports multiple targeted advertisements depending on day and/or time, the metadata may also be used to determine which from a multiple of associated targeted advertisements is to be shown.

At block 516, upon completion of the targeted advertisement (or, in the event that there is no targeted ad stored in associated with the requested program, in response to the viewer request to watch the program), client device 208 renders the requested program.

Blocks 518-526 illustrate an additional way in which advertisements may be targeted to viewers of on-demand media content.

At block 518, client device 208 detects that the viewer has initiated a pause feature, for example, by pressing a pause button on a remote control device.

At block 520, client device 208 waits a pre-configured amount of time (e.g., 20 seconds).

At block 522, client device 208 determines whether or not there is a stored advertisement to be targeted to viewers of the program that is currently being shown during a pause. If there is no such advertisement stored in ad data store 322 (the “No” branch from block 522), then processing continues at block 526.

At block 524, when a targeted advertisement associated with a pause in the currently playing program is detected, the targeted advertisement is played. In an exemplary implementation, advertisements that are played during a pause are still image advertisements, rather than video advertisements. In an exemplary implementation, such still image advertisements may be further targeted based on day and/or time, as described above with reference to traditional advertisements.

At block 526, client device 208 detects that a viewer has initiated a play feature, for example, by pressing a play button on a remote control device.

At block 516, in response to receiving a play command, client device 208 continues playing the program.

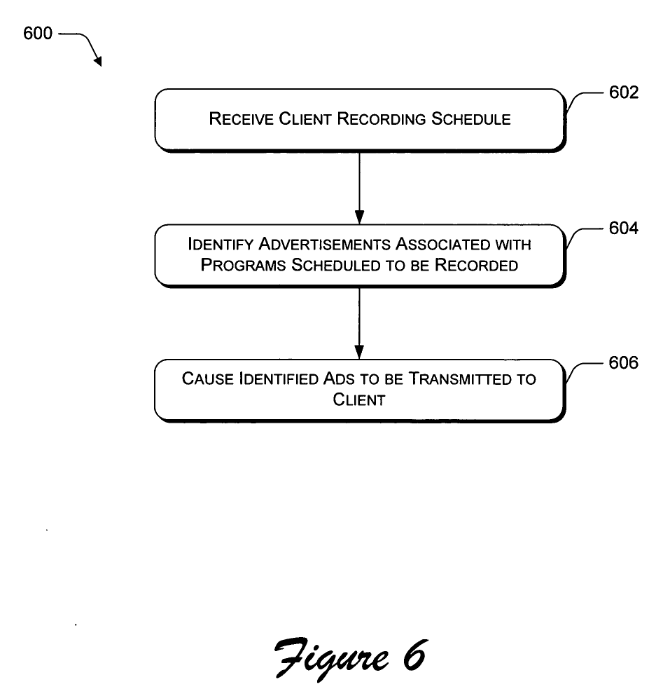

FIG. 6 is a flow diagram that illustrates an exemplary method 600 for associating advertisements with on-demand media content. The illustrated process can be implemented in any suitable hardware, software, firmware or combination thereof.

At block 602, ad application server 212 receives a client recording schedule. The recording schedule indicates one or more broadcast television programs that have been scheduled to be recorded using one or more client devices 208. In the described implementation, the received data is stored in recording schedules data repository 412.

At block 604, ad application server 212 identifies one or more advertisements to be targeted to viewers of the programs that have been scheduled to be recorded. For example, ad targeting application 408 compares data stored in recording schedules data repository 412 to data stored in asset correlation data repository 414. Based on the comparison, ad targeting application 408 identifies advertisements that are to be targeted to viewers of the programs that are scheduled to be recorded.

At block 606, ad application server 212 causes the identified advertisements to be transmitted to the respective client devices 208 from which the recording schedule data was received. For example, client device ID/ad ID pairs may be transmitted to headend 204, which then instructs VOD server 214 to transmit the specified ads to the specified client devices.

Metadata may also be transmitted with the ads indicating additional conditions under which one or more of the ads are to be shown. For example, two ads may be transmitted to be associated with a particular program. Associated metadata may indicate that one of the ads is to be shown on particular days and/or at particular times, while the other ad is to be shown on different days and/or at different times.

### CONCLUSION

The techniques described above enable targeting of advertisements to consumers of on-demand media content. Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
receiving a user request to render an on-demand media content;
identifying an advertisement associated with the on-demand media content; and
rendering the advertisement in conjunction with rendering the on-demand media content.

2. The method as recited in claim 1 wherein the on-demand media content comprises video-on-demand available from a server.

3. The method as recited in claim 1 wherein the on-demand media content comprises a previously recorded broadcast television program.

4. The method as recited in claim 1 wherein the identifying comprises:
transmitting data to a server, the data identifying a broadcast television program that is scheduled to be recorded; and
receiving advertisement data associated with the broadcast television program that is scheduled to be recorded.

5. The method as recited in claim 4 wherein the advertisement data comprises advertisement video content.

6. The method as recited in claim 4 wherein the advertisement data comprises an advertisement image.

7. The method as recited in claim 4 wherein the advertisement data comprises advertisement metadata, the metadata comprising business rules associated with an advertisement.

8. The method as recited in claim 7 wherein the business rules comprise at least one of an indicator of how often the advertisement is to be played, an indicator of which trick modes are to be disabled during the playing of the advertisement, an expiration date associated with the advertisement, a day of the week that the advertisement is to be played, or a time of day at which the advertisement is to be played.

9. The method as recited in claim 1 wherein the rendering the advertisement in conjunction with rendering the on-demand media content comprises:
rendering the advertisement; and
upon completion of the advertisement, rendering the on-demand media content.

10. The method as recited in claim 1 wherein the rendering the advertisement in conjunction with rendering the on-demand media content comprises:
rendering the on-demand media content;
detecting initiation of a pause command before the conclusion of the on-demand media content;
rendering the advertisement while the on-demand media content is paused; and
upon detection of termination of the pause command, continuing to render the on-demand media content.

11. The method as recited in claim 1 further comprising:
generating ad tracking data associated with the advertisement; and
transmitting the ad tracking data to a server system.

12. The method as recited in claim 11 wherein the generating comprises recording a date at which the advertisement is played.

13. The method as recited in claim 11 wherein the generating comprises recording a time at which the advertisement is played.

14. The method as recited in claim 11 wherein the generating comprises recording an indicator of whether or not a viewer attempted to fast-forward through the advertisement.

15. One or more computer-readable media having computer-readable instructions thereon which, when executed by a computer, cause the computer to implement the method as recited in claim 1.

16. A system comprising:
means for recording a broadcast television program;
means for transmitting data identifying the broadcast television program to a server system;
means for receiving an advertisement associated with the broadcast television program; and
means for rendering the advertisement in conjunction with the broadcast television program that is recorded.

17. The system as recited in claim 16 further comprising means for transmitting ad tracking data to the server system, the ad tracking data comprising indicators of conditions under which the advertisement was rendered.

18. The system as recited in claim 16, implemented as at least one of a cable television system set-top box, a digital video recorder, a digital cable-ready television set, a personal computer, and a satellite television receiver.

19. A system comprising:
a processor;
a memory; and
an ad targeting application stored in the memory and executed on the processor, the ad targeting application configured to:
receive data identifying a broadcast television program scheduled to be recorded on a recording device;
identify an advertisement to be targeted to viewers of the broadcast television program; and
cause the advertisement to be transmitted to the recording device.

20. The system as recited in claim 19 further comprising an ad tracking application stored in the memory and executed on the processor, the ad tracking application configured to receive and store ad tracking data associated with an advertisement that has been rendered in conjunction with on-demand media content.

21. The system as recited in claim 20 wherein the ad tracking data identifies a date and time at which the advertisement was played.

22. One or more computer-readable media comprising computer-readable instructions which, when executed, cause a computer system to:
receive a user request to record a broadcast television program;
transmit data identifying the broadcast television program to a server system; and
receive an advertisement associated with the broadcast television program.

23. The one or more computer-readable media as recited in claim 22, further comprising computer-readable media comprising computer-readable instructions which, when executed, cause a computer system to:
record the broadcast television program;
receive a user request to view the broadcast television program that was recorded; and
render the advertisement in conjunction with rendering the broadcast television program that was recorded.

24. The one or more computer-readable media as recited in claim 23, further comprising computer-readable media comprising computer-readable instructions which, when executed, cause a computer system to select based on a day and/or time, the advertisement from multiple advertisements associated with the broadcast television program.

25. The one or more computer-readable media as recited in claim 23, further comprising computer-readable media comprising computer-readable instructions which, when executed, cause a computer system to:
record tracking data that describes conditions associated with the rendering of the advertisement; and
transmit the tracking data to the server system.

26. One or more computer-readable media comprising computer-readable instructions which, when executed, cause a computer system to:
receive from a client device, data identifying a broadcast television program that is scheduled to be recorded;
identify an advertisement to be targeted to viewers of the broadcast television program; and
cause the advertisement to be transmitted to the client device.

27. The one or more computer-readable media as recited in claim 26, further comprising computer-readable media comprising computer-readable instructions which, when executed, cause a computer system to receive tracking data that describes conditions associated with a rendering of the advertisement.
